(19) United States
(12) Patent Application Publication
(10) Pub. No.: US 2003/0079628 A1
(43) Pub. Date: May 1, 2003

(54) Process and apparatus for integrated printing form production in a processing machine

(76) Inventor: Thomas Walther, Freigericht (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/285,252

(22) Filed: Oct. 31, 2002

(30) Foreign Application Priority Data
Oct. 31, 2001 (DE) 101 53 794.8

(51) Int. Cl. B41F 7/02

(52) U.S. Cl. 101/217

(57) ABSTRACT

An apparatus and method for integrated printed form production in a printing machine having a printing form cylinder with a rubber printing blanket. The apparatus includes a thermal transfer ribbon disposed adjacent the printing form cylinder, an image setting device for setting a printing image on the thermal transfer ribbon for direct transfer to the printing form cylinder, and a fixing device for thermally fixing the printing image on the rubber printing blanket such that upon inking of the printing form cylinder the printing image can be transferred directly to material directed through a press nip formed in part by the printing form cylinder.

### FIELD OF THE INVENTION

The present invention relates generally to a method and apparatus for the integrated production of printing forms in a processing machine, and more particularly, in a printing machine.

### BACKGROUND OF THE INVENTION

A method and an apparatus for making printing forms for an offset printing machine are disclosed in DE 32 48 178 A1. According to this reference, a thermal transfer ribbon with an electronically controlled image-point thermal transfer unit, namely a thermal transfer device, is arranged immediately adjacent to a printing form cylinder. By means of the action of point by point energy, such as by means of a laser, in accordance with electronic printing image information, an oleophilic material is detached from the thermal transfer ribbon, transferred to the printing form cylinder and fixed on the outer surface of the latter for the purpose of forming the printing points. The outer surface of the printing form cylinder which accepts the oleophilic material is metallic, such as an anodized or brushed aluminum surface. The printing form cylinder is acted on with the necessary image information by the thermal transfer printing unit during at least one revolution. Also associated with the printing form cylinder is a device for removing images, that is to say erasing, the printing form. After the images have been removed from the printing form, renewed printing form production in accordance with the foregoing process can be performed on the printing form cylinder. The thermal transfer printing unit can be used on the printing form cylinder in each case.

As is known, offset printing units have at least one plate cylinder which carries the printing form, also called a printing form cylinder. Such printing units further have a blanket cylinder which serves as a transfer cylinder for the printing material to be inked or varnished.

The printing subject is therefore transferred from the printing form of the plate cylinder to the blanket cylinder and from the blanket cylinder to the printing material in an indirect planographic printing process, such that use of a printing form according to DE 32 48 178 A1 is carried out in an indirect planographic printing process.

### OBJECTS AND SUMMARY OF THE INVENTION

The present invention relates to a method and apparatus which avoids disadvantages of the prior art and which permits a simplified printing unit construction with an expanded field of use.

Another object is to provide a method and apparatus as characterized above which enables the elimination of one cylinder per printing unit, and hence, reduces the cost of the printing unit.

A first and significant advantage of the invention arises from the fact that the printing unit may be more economically produced by requiring only a single printing form cylinder and a single impression cylinder per unit. As a result, by eliminating one cylinder per unit in each case, the expenditure is appreciably reduced by virtue of the simplified printing unit construction in comparison to conventional printing units which require a plate cylinder, blanket cylinder and impression cylinder.

A further advantage is based on the fact that the transfer of ink or varnish to the printing material is carried out directly, that is to say in a direct printing process from the inked printing form directly to the printing material.

A further advantage is based on the fact that the printing form cylinder can be provided with any desired inking system, which may be based on different principles of ink metering or ink splitting.

It will be understood that the apparatus of the invention is not restricted to inking the printing form with printing ink. Instead of printing ink, a varnish, for example a water-based varnish, can be used in conjunction with the printing form. Furthermore, the apparatus for integrated printing form production is not restricted to printing units and/or varnishing units in a printing machine. The apparatus also can be used, for example, in varnishing units of a varnishing machine. In such case, the apparatus can be permanently installed in relation to the respective printing form cylinder. Alternatively, at least one such apparatus may be associated with the processing machine in such a way, that, for example by means of a handling technique or linking system, the apparatus can be brought to and removed from the printing form cylinder on which an image is to be set.

Other objects and advantages of the invention will become apparent upon reading the following detailed description and upon reference to the drawings, in which:

### BRIEF DESCRIPTION OF THE DRAWING

FIG. 1 is a diagrammatic depiction of a printing unit having a printing form production apparatus in accordance with the invention.

While the invention is susceptible of various modifications and alternative constructions, certain illustrated embodiments thereof have been shown in the drawings and will be described below in detail. It should be understood, however, that there is no intention to limit the invention to the specific forms disclosed, but on the contrary, the intention is to cover all modifications, alternative constructions and equivalents falling within the spirit and scope of the invention.

### DETAILED DESCRIPTION OF THE PREFERRED EMBODIMENTS

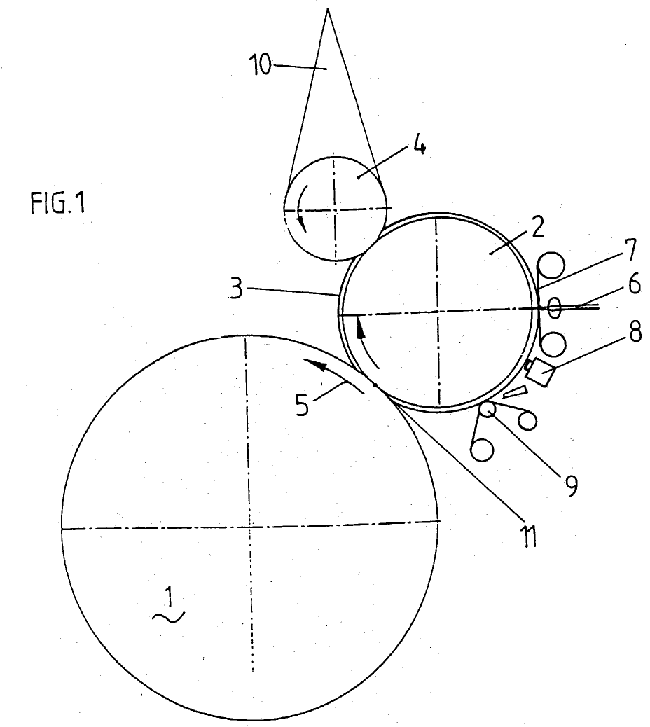

Referring now more particularly to FIG. 1, there is shown an illustrative printing unit of a rotary printing machine in accordance with the invention. The printing machine in this case includes a printing form cylinder 2 and an inking system 10 for supplying ink to the form cylinder 2. The inking system 10 in this case includes an applicator roll 4 which can be thrown between on and off positions in a known manner. The inking system 10 of this type is, for example, a roll train of an inking unit that includes the applicator roll, or a metering system operatively associated with the applicator roll 4.

Metering systems that can be used in the metering unit include a chamber-type doctor coupled to the applicator roll 4 (i.e., chamber-type doctor system), or a dip roll dipping into a container of varnish or ink and coupled directly or indirectly to the applicator roll 4 (i.e., dip roll system), or a two-roll system including the applicator roll 4 and having an ink or varnish feed feeding into a common nip (i.e., pinch roll system). Alternatively, upstream of the inking system 10 and applicator roll 4, in the direction of rotation of the printing form cylinder 2, a damping unit can be provided that can be thrown on or off the printing form cylinder 2.

Detachably arranged about the printing form cylinder 2 is a rubber printing blanket 3 which can be brought directly into contact with the inking system 10 or the applicator roll 4. The printing form cylinder 2 with the rubber printing blanket 3 can be brought directly into contact with a printing material transported in the conveying direction 5 through a press nip 11 formed between the form cylinder and an adjacent impression cylinder 1. The impression cylinder 1, for example, may be a sheet-carrying cylinder of a sheet-processing machine having sheet-holding means or an impression cylinder in a web-processing printing machine. Alternatively, the impression cylinder also can be designed as a printing form cylinder 2 having a rubber printing blanket 3, which may be an associated apparatus for integrated printing form production based upon thermal transfer principles, preferably in a web-processing printing machine.

In accordance with the invention, adjacent to the printing form cylinder 2 with the rubber printing blanket 3 is an image-setting device 6 having a thermal transfer ribbon 7 arranged between the image setting device 6 and the printing form cylinder 2. The image-setting unit 6 is a device preferably designed as a laser image-setting head, which receives digital image data from a controller, for example a control desk. The thermal transfer ribbon 7 has a special polymer as a coating and can preferably be brought into contact with the rubber printing blanket 3. The image-setting unit 6 heats the thermal transfer ribbon 7 pixel by pixel in accordance with the image information to be transferred, and the polymer is transferred point by point to the rubber printing blanket 3. The printing image information can therefore be transferred directly from the thermal transfer ribbon 7 to the rubber printing blanket 3. Since the polymer carries ink, it forms the printing points on the rubber printing blanket 3.

The rubber printing blanket 3 has a surface coating which is preferably hydrophobic. For example, such a surface coating is formed from a silicone rubber layer. Incompressible or preferably compressible rubber printing blankets 3 including air cushions can be used as the rubber printing blanket 3.

The rubber printing blanket 3 preferably has a dimensionally stable substrate. According to a first design, the substrate is a sleeve which can be pulled axially onto the printing form cylinder 2 and can be arranged to adhere firmly, but detachably, to the surface of the cylinder. In a second design, the substrate may be a carrier layer on which the rubber printing blanket 3 is arranged to adhere firmly, and at least the substrate can be fixed by clamping means on the printing form cylinder 2. In a third design, the substrate may be arranged as an intermediate layer inside the rubber printing blanket 3, with the rubber printing blanket 3 being fixed in clamping means on the printing form cylinder 2.

In the direction of rotation of the printing form cylinder 2, the image-setting device 6 with a thermal transfer ribbon 7 is followed by a thermal fixing device 8, which fixes the printing subject onto the rubber printing blanket 3, preferably to ensure better retention. A conditioning process preferably follows in order to improve the acceptance of ink/damping solution.

In the direction of rotation of the printing form cylinder 2, the thermal fixing device 8 is followed by a cleaning device 9. The cleaning device 9 preferably is activated after the completion of the printing and removes the image of the respective printing subject from the rubber printing blanket 3, that is to say the printing subject on the rubber printing blanket 3 is erased.

The operating process for integrated printing form production on a processing machine having at least one printing form cylinder, an image-setting device and a thermal transfer ribbon arranged between the image-setting device and the printing form cylinder to transfer printing image information to the printing form cylinder, and also a device for thermal fixing of the printing image information on the printing form cylinder, and a cleaning device for removing or erasing the images the printing image information on the printing form cylinder is as follows:

The printing image information preferably is transferred pixel by pixel from the thermal transfer ribbon 7, which is preferably polymer-coated, directly to the rubber printing blanket 3 fixed to the printing form cylinder 2 in order to produce the printing subject and is fixed there by means of the device for thermal fixing. For this purpose, the thermal transfer ribbon 7 is preferably in contact with the rubber printing blanket 3. In such case, the polymer applied to the rubber printing blanket 3 carries ink. The rubber printing blanket 3 is then inked by an inking system 10, 4 which can be thrown on and off, and the printing subject is transferred directly to a printing material from the rubber printing blanket 3 in a press nip 11.

As required, the printing subject on the rubber printing blanket 3 may be erased by means of the cleaning device for removing images. If required, before the rubber printing blanket 3 is inked, it may be wetted with a damping solution.

What is claimed:

1. An apparatus for integrated printing form production in a processing machine comprising a printing form cylinder having a rubber printing blanket, an impression cylinder adjacent to said printing form cylinder and defining a press nit with said printing form cylinder through which material to be printed is directed, a thermal transfer ribbon disposed in adjacent relation to said printing form cylinder, a image setting device for setting a printing image on said thermal transfer ribbon, said thermal transfer ribbon being disposed between image setting device and printing form cylinder for directly transferring the printing image from said ribbon to the rubber printing blanket of said printing form cylinder during rotation of said printing form cylinder, a thermal fixing device for thermally affixing the printing image on said rubber printing blanket, an inking system for inking said printing form cylinder after thermal setting of said printing image thereon so that the printing image can be transferred from said printing form cylinder directly to printing material directed through said press nip.

2. The apparatus of claim 1 in which said printing blanket has a dimensionally stable substrate.

3. The apparatus of claim 1 in which said rubber printing blanket is detachably mountable on the printing form cylinder.

4. The apparatus of claim 1 including a cleaning device for removing said printing image from said rubber printing blanket as an incident to rotation of said printing form cylinder following transfer of the printing image to said sheet material.

5. The apparatus of claim 1 in which said rubber printing blanket has a hydrophobic surface coating.

6. The apparatus of claim 5 in which said rubber printing blanket has a silicone rubber layer as a surface coating.

7. The apparatus of claim 1 in which said rubber printing blanket is a compressible rubber blanket with air cushions.

8. The apparatus of claim 2 in which said dimensionally stable substrate is a sleeve on which the rubber printing blanket is firmly adhered.

9. The apparatus of claim 2 in which said dimensionally stable substrate has a carrier layer on which the rubber printing blanket is firmly adhered, and said printing form cylinder has clamps for affixing said substrate on said printing form cylinder.

10. The apparatus of claim 2 in which said dimensionally stable substrate is an intermediate layer inside the rubber printing blanket.

11. The apparatus of claim 1 in which said printing form cylinder has clamps for releasably securing said rubber printing form about said printing form cylinder.

12. The apparatus of claim 1 in which said impression cylinder is a sheet carrying cylinder.

13. The apparatus of claim 1 in which said impression cylinder is a printing form cylinder that carries a rubber printing blanket.

14. A process for integrated printing form production in a processing machine having at least one rotatable printing form cylinder having a printing blanket comprising the steps of transferring printing image information from a thermal transfer ribbon directly onto the printing blanket of the printing form cylinder as the printing form cylinder is rotated to produce a printing subject on the printing blanket, inking the printing blanket after producing the printing subject thereon, and transferring the printed subject from the printing blanket after inking directly to a printing surface in a printing nip defined in part by the printing form cylinder.

15. The process of claim 14 including transferring the printing image information to the thermal transfer ribbon by an image setting device, and thermally affixing the printing subject on the printing blanket following transfer of the printing subject to the printing blanket from said transfer ribbon and prior to inking of the printing blanket.

16. The process of claim 14 including removing the printing subject from the printing blanket following transferring of the printing subject to the printing material.
